(19) United States
(12) Patent Application Publication
(10) Pub. No.: US 2002/0111854 A1
(43) Pub. Date: Aug. 15, 2002

(54) Entertainment method and device for promoting a sponsor

(76) Inventors: Ronen Yotam, Tel Aviv (IL); Baruch Shugol, Tel Aviv (IL)

Correspondence Address: BROWDY AND NEIMARK, P.L.L.C., 624 Ninth Street, N.W., Washington, DC, 20001, US

(21) Appl. No.: 09/768,793

(22) Filed: Jan. 25, 2001

(51) Int. Cl. G06F 17/60

(52) U.S. Cl. 705/14

(57) ABSTRACT

A method for promoting products of a plurality of advertisers, wherein a questionnaire is provided typically as a supplement for circulation with a journal or newspaper, the questionaire containing a number of questions at least some of which require a level of knowledge beyond that of an expected target audience. The questionnaire contains a link to a source of information providing clues as to the answers to the questions and being interspersed with information about the advertisers and their products. A targeted reader answers the questions, prompted by the allure of a large cash reward if he or she answers all the questions correctly. In order to do, however, the reader must access the source of information so as to obtain the necessary clues. In perusing the information, he is exposed to and digests detailed advertising blurb about each advertiser. Upon receiving answers to the questions from interested participants, the promoter enters completely correct answers to a lottery having a cash award financed by the advertisers, and awards the cash award to a wining entry of the lottery.

### FIELD OF THE INVENTION

This invention relates to games and advertising.

### BACKGROUND OF THE INVENTION

It is known to generate advertising revenue and to sponsor events by distributing brochures in which advertisers purchase space. The brochures may be distributed to targeted participants, such as guests at a gala dinner or may be placed as a supplement into a daily newspaper, for example, so as to reach a wide audience. Typically, advertisements placed in such brochures are succinct, since there is little expectation that the target audience would expend energy on reading lengthy articles placed by an advertiser. To the extent that such advertisements nevertheless help finance the event at which they are distributed or the host journal with which they are circulated, they are of obvious benefit to the event organizer or to the host. But they are of limited benefit to the advertiser, who may reach a wide audience but might well prefer a smaller but better targeted audience. Indeed, brochures of this sort most often serve more as a vehicle to promote the good name of the advertiser than as source of advertising information. This is particularly true in connection with brochures that are associated with charity events and the like.

Promotion of this kind is also important but is clearly in addition to, and not instead of, more informative advertising intended not merely to promote the name and goodwill of the advertiser but to inform the public of his products and services.

WO 023160A1 in the name of BE.Scedil.LEAGA entitled “Crossword Game Coupon” describes a crossword game coupon created for all types of contestants. It reunites all the main characteristics of a game: educational, prize winning as well as penetrating a product or a service by catching the publics' eye by advertising ads. It has an educational role, it is a coupon for prize winning and it has an advertising role. The crossword game coupon is foreseen with definitions and empty reserved spaces for answers. On the back of the crossword game coupon are preprinted fields for advertising. The crossword can be sold individually or together with another publication.

The crossword puzzle subject of WO 023160A1 thus serves as both a form of entertainment and as a vehicle for promoting a sponsor. At the same, by its very nature, the crossword puzzle also serves an educational role. However, there appears to be no suggestion to use the crossword puzzle to inform the reader about the sponsor or the products or services that he supplies.

Even apart from this, crossword puzzles appeal to a very distinct target group and can hardly be said to be of universal appeal. It is probably not being unduly cynical to assert that the promise of a cash award is maybe the only offer having truly universal appeal. But the appeal of a large cash reward is not easily exploited by an advertiser having a limited budget; nor does the offer of a cash reward encourage the recipient to take a true interest in the products or services being promoted. There is therefore a need to provide an entertaining vehicle for promoting a detailed interest in the goods and services offered by an advertiser, which offers both an intellectual and cash incentive to the target audience.

### SUMMARY OF THE INVENTION

It is therefore an object of the present invention to provide an entertaining vehicle for promoting a detailed interest in the goods and services offered by an advertiser, which offers both an intellectual and cash incentive to the target audience.

This object is realized in accordance with a first aspect of the invention by a method for promoting products of a plurality of advertisers, the method comprising the following steps all carried out by a promoter:

a. distributing a questionnaire containing a number of questions at least some of which require a level of knowledge beyond that of an expected target audience,

b. providing in the questionnaire a link to a source of information providing clues as to the answers to the questions and being interspersed with information about the advertisers and their products,

c. receiving answers to the questions from interested participants,

d. entering completely correct answers to a lottery having a cash award financed by the advertisers, and

e. awarding the cash award to a wining entry of the lottery.

According to a second aspect of the invention there is provided a method for promoting products of a plurality of advertisers, the method comprising the following steps all carried out by a targeted reader:

a. receiving a questionnaire containing a number of questions at least some of which require a level of knowledge beyond that of an expected target audience,

b. following a link in the questionnaire to a source of information providing clues as to the answers to the questions and being interspersed with information about the advertisers and their products, and

c. completing answers to the questions and forwarding to a promoter.

According to a third aspect of the invention there is provided a questionnaire containing a number of questions at least some of which require a level of knowledge beyond that of an expected target audience, and containing a link to a source of information providing clues as to the answers to the questions and being interspersed with information about the advertisers and their products.

According to yet another aspect of the invention, there is provided a method for promoting a business's products or services, including the following steps all carried out by an advertising agency:

a. reviewing the business's products and services,

b. compiling a questionnaire including suitable questions at least some of which require a level of knowledge beyond that of an expected target audience,

c. compiling source material providing extensive information about the business's products and services and including clues to the questions, and

d. rendering both the questionnaire and the source material publicly accessible.

The advertising agency can be an independent agency serving the advertisers or the promoter can himself serve as the advertising agency.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a flow diagram showing the principal steps carried out by a promoter for promoting advertisers' products according to the invention;

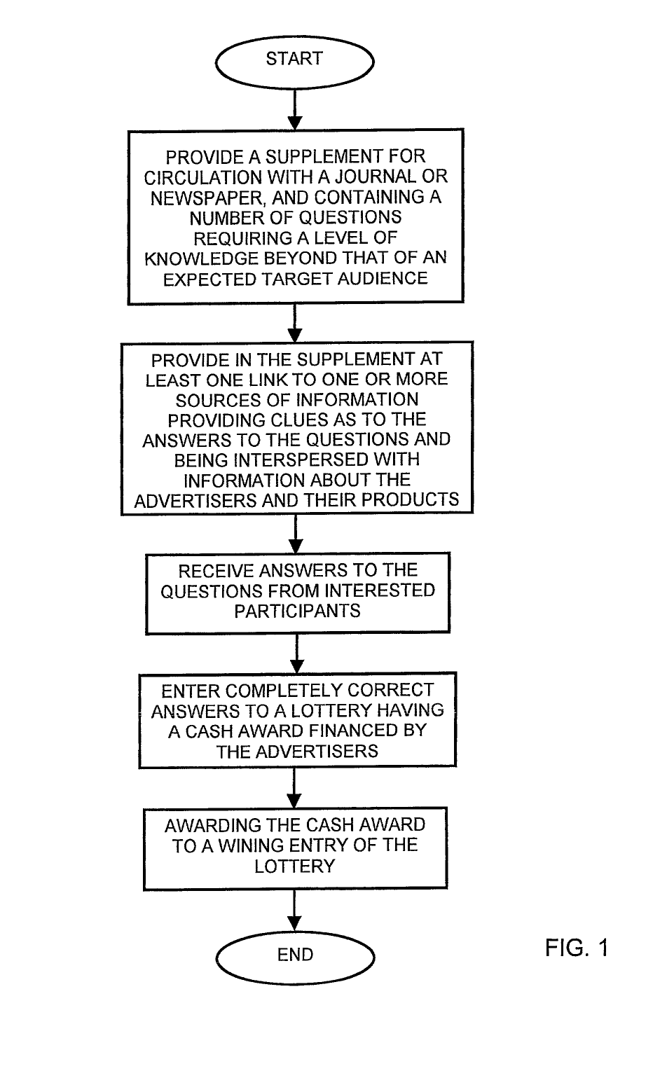

FIG. 2 is a flow diagram showing the principal steps carried out by a targeted reader according to the invention;

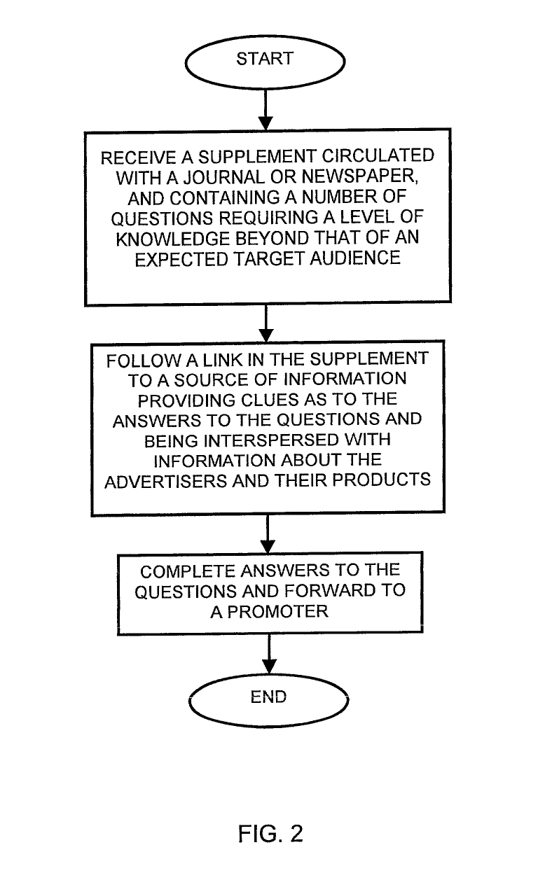

FIG. 3 is a flow diagram showing the principal steps carried out by an agency devising questions for promoting advertisers' products according to the invention; and

FIG. 4 is a block diagram showing functionally a computer system for carrying out the principal method steps of the invention.

### DETAILED DESCRIPTION OF THE INVENTION

Referring to the figures there will be described various approaches for a promoter to promote advertisers' products in accordance with the invention. The promoter publishes a supplement that is financed by the advertisers and is circulated with a journal or newspaper reaching a target audience. In the case of a national daily newspaper or magazine, the target audience is clearly very broad, while an advertiser of computer equipment might prefer for the supplement to be circulated with a computer magazine having lower circulation in absolute terms, but a statistically more receptive target audience. The supplement contains a number of questions at least some of which require a level of knowledge beyond that of the expected target audience. Typically, the questions are compiled by or on behalf of each of the advertisers and there are provided in the supplement a link to a source of information providing clues as to the answers to the questions and being interspersed with information about the advertisers and their products. Thus questions and the clues are so compiled as to provide extensive information about the advertiser and his products and services, so that by reviewing the source material in order to find clues to the answers, the reader inevitably learns much more about the advertiser and his wares than would be possible in a regular brochure. Moreover, such an approach exploits the fact that the reader is very much a captive audience, and information may be imparted at a level that might discourage the reader from bothering to read the material under normal circumstances.

The supplement is typically divided into pages each sponsored by a different advertiser and includes a small number of questions. By way of example, the supplement might contain 30 pages each posing four questions, thus making a total of 120 questions and allowing sponsorship of the prize money to be shared amongst the thirty advertisers. Completely correct answers received by a specified date are eligible for entry into a grand lottery financed by the advertisers, typically (but not necessarily) offering a single grand prize of $1,000,000 or 1 million units or more of local currency.

A reader is prompted to exert himself to answer the questions for one of two main reasons. First, of course, is the allure of the grand draw and the possibility of winning a vast sum of money. It will be appreciated that the odds of winning are very much greater than conventional lottery games where vast numbers of contestants participate and which are based on nothing more than chance. The lottery subject of the invention is only partly a function of chance in that the actual final winner is selected randomly from all eligible entries. However, even before the winner can be eligible to enter the lottery, he or she must answer all 120 questions correctly. This requires skill and careful attention to the clues provided in the source material indexed by the links in the supplement and this eliminates many participants. Thus, the chance of a correct entrant winning is certainly very much higher than common games of chance. This gives rise to a second incentive to participating in the game and making the effort to win: namely the sheer intellectual effort required and the commensurate feeling of a job well done on reaching a full score.

The promoter receives answers to the questions from interested participants, and enters only those answers that are completely correct to a lottery having a cash award financed by the advertisers, the cash award being awarded to a wining entry of the lottery.

Obviously, modifications may be effected to actual implementation of such a scheme without departing from the overall inventive concept. For example, the prize money can be shared between more than one winning entry if desired. It should also be noted that preferably there is provided a different link for each advertiser. Thus, in the case that each advertiser sponsors a page in the supplement, the respective page can show a link to the advertiser's web site. Most generally, the link is an address for allowing an interested participant to obtain the information. The address is most typically a URL of a website providing the information, thus requiring the reader to access the advertiser's website via the Internet. However, mindful of the fact that not all readers have access to the Internet, the link can also be a contact address for allowing an interested participant to request receipt of the information in non-electronic form. For example, such a contact address can be a regular mailing address, or a telephone or fax number.

In the case that the advertising source material is downloaded to the reader electronically, the link can also be a URL of a website operated on behalf of the promoter and providing links to websites of each advertiser. Likewise, the promoter can serve as a central depository responsible for storing the advertiser's source material and forwarding it to readers accessing the promoter's website. Such an approach is particularly feasible if an advertiser has no website and allows such an advertiser nevertheless to participate in the scheme.

Where a reader accesses the advertisers' websites via the promoter's website, the promoter's website may offer multilingual data offering linkage to language-selectable websites of the respective advertisers. Likewise, the advertisers' websites may themselves offer multilingual facility, providing access to linked websites in different selectable languages.

The reader sends the completed questionnaire to the promoter, this being achieved in any suitable manner. For example, the questionnaire can be downloaded by the reader through the Internet or by e-mail, completed with the aid of a computer and then returned to the promoter in similar manner, via the Internet or by e-mail. This is particularly applicable to the filling in of American-style or multiple-choice tests. On the other hand, for non-Internet users the option exists to return the completed questionnaire by mail or fax. In all cases, it may not be required to complete the questionnaire in the sense that answers are written on the questionnaire itself and answers can be returned in any suitable form as permitted by the promoter.

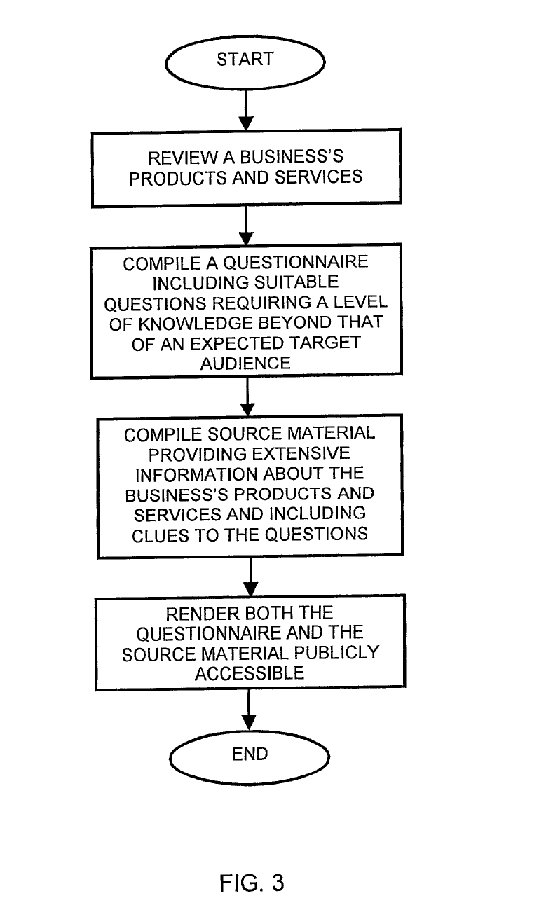

The questions may be compiled by the advertisers or on their behalf by a professional agency that may be better equipped to pose questions of the required difficulty and to provide suitable clues. Such an agency may also form a business in its own right by providing a service to advertisers that has not been hitherto provided. Obviously, the promoter may himself be equipped to provide this service, the principal details of which are shown in FIG. 3 and include reviewing an advertiser's products and services, compiling a questionnaire including suitable questions, compiling source material providing extensive information about the advertiser's products and services and including clues to the questions and rendering both the questionnaire and the source material publicly accessible.

It should also be noted that whilst the invention has been described with particular regard to a supplement provided as an insert for a host newspaper or other journal, it is also envisaged that the supplement may be provided entirely electronically and distributed over the Internet or by e-mail. In this case, the promoter can access e-mail addresses of targeted readers and send them the supplement in electronic form and, in due course, receive the completed questionnaire also by e-mail or over the Internet. In this case, the various steps carried out by the promoter and the targeted readers are effectively performed by computer programs. It will thus be understood that the invention may be implemented by suitably programmed computers. Likewise, the invention contemplates a computer program being readable by a computer for executing the method of the invention. The invention further contemplates a machine-readable memory tangibly embodying a program of instructions executable by the machine for executing the method of the invention.

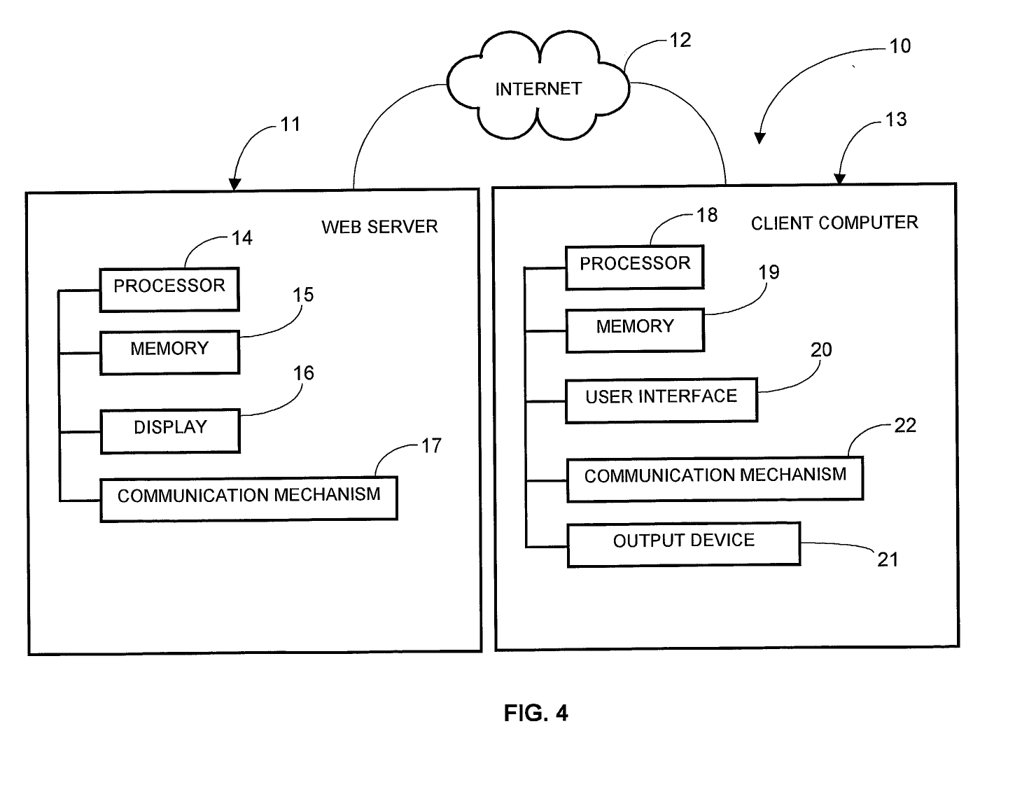

FIG. 4 is a block diagram showing functionally a computer system 10 for distributing and processing the questionnaire electronically. The system 10 comprises a promoter web server 11 coupled by the Internet 12 to a client machine 13. The web server 11 comprises a processor 14 coupled to a memory 15, an output device 16 such as a display and/or printer and a communication mechanism 17 allowing communication with the client machine 13. The client machine 13 comprises a processor 18 coupled to a memory 19, a user interface 20 typically including a keyboard and./or mouse, an output device 21 such as a display and/or printer and a communication mechanism 22 allowing communication with the web server 11.

The processor 14 in the web server 11 is programmed to distribute questionnaires to the client machine 13 and to receive answers therefrom. The processor 14 is further adapted to analyze the answers and assign a score and to mark completely correct answers for entry to a lottery. The processor 18 in the client machine 13 is programmed to cache a questionnaire received via the communication mechanism 17 in the memory 19 and to allow a user to access links that are embedded in the questionnaire and redirect the user to one or more advertiser websites for obtaining clues to the answers to the questions in the questionnaire. The user can compile answers using the user interface 20 and send completed answers back to the web server 11, or to another web server associated therewith.

The invention also contemplates the possibility to associate the questionnaire with a television program, so that viewers can access the promoter for receiving the questionnaire and thereafter process the questionnaire either manually or electronically as explained above. Such a combination lends itself to application over cable Internet, where a program transmitted over cable may include links for accessing advertisers' websites and allow completed answers to be sent electronically to the promoter's website.

Yet another possibility is to relay the questionnaire via a television program. This can be done by displaying the questionnaire, or at least part thereof, for viewing by the home audience. As a variation of this theme, the questions may be directed to an advertiser's products and may be so compiled that a viewer with a keen familiarity of those products can answer the questions even without recourse to the additional source material as described above. In this case, viewers can answer the questions during the program so that the first completely correct answers relating to a specific advertiser wins a prize. Typically, the prize is sponsored by the same advertiser and may, for example, be free samples of his products.

Advertisers may likewise sponsor intermediate prizes in addition to their sponsoring the grand cash draw. For example, some or all of the advertisers may sponsor a number of free samples of their products or services to a specified number of runners up. For example, a Cola manufacturer might opt to give away several cases of their Cola to runners up, thus giving a feeling of achievement even to those who do not strike lucky with the grand cash prize.

However, a television centered round the lottery might also serve as a vehicle for presenting the questions in a quiz-type of program and including a grand lottery for which totally correct entrants are eligible. Thus, again considering the example of 30 advertisers each posing four questions and jointly sponsoring such a program. The 120 questions are presented to the studio audience and/or home viewers. In the case of a studio audience, some members of the audience may participate in answering questions in the program and at the end of the program may be eligible for participation in the lottery together with successful home viewers.

At least two approaches are envisaged. In a simple case, as explained above, the questions may be so compiled that a skilled viewer can answer the questions even without recourse to the additional source material. In this case, viewers can answer the questions during the program so that the first completely correct answers relating to a specific advertiser wins a prize. Likewise, home viewers can answer either by telephone or via an Internet or e-mail connection. Alternatively, as also envisaged above, with the increasing proliferation of cable TV, the cable may itself serve as the medium for communication between the TV program and the viewer at home.

Apart form the obvious entertainment benefit and possible educational value to the viewers, such an approach has added value to the advertisers since they are able to target a much larger audience. In the case that the questions are directed to the sponsors' products and services, the TV program serves as an excellent propaganda source for the sponsoring advertisers. Moreover, such a TV program may act as an additional advertisement source to the supplement, thus attracting the attention not only of those who receive the supplement, but also the much wider TV audience— including the studio audience and the viewers at home. From the TV company's perspective, too, the scheme has obvious benefit. First, the program may be made highly entertaining and thus attract a high rating. Moreover, it need cost the TV company nothing to produce such a program, since it may be totally financed by the advertisers or nearly so.

An alternative approach is for more searching questions to be asked and for answers to be provided in a similar manner in time for the next program in the series. Likewise, the supplement may opt not to include the questions but may inform the targeted reader that the questions will be announced on a specified radio or television program, on a given channel and date/time slot. This, too, increases the ratings of the radio or television program, since all interested participants will tune in to the program in order to receive further details. The TV channel can, of course, be cable TV, Internet and even intranet in addition to conventional channels.

1. A method for promoting products of a plurality of advertisers, the method comprising the following steps all carried out by a promoter:
(a) distributing a questionnaire financed by the advertisers, said questionnaire containing a number of questions at least some of which require a level of knowledge beyond that of an expected target audience,
(b) providing in the questionnaire a link to a source of information providing clues as to the answers to the questions and being interspersed with information about the advertisers and their products,
(e) receiving answers to the questions from interested participants,
(d) entering completely correct answers to a lottery having a cash award financed by the advertisers, and
(e) awarding the cash award to a wining entry of the lottery.

2. The method according to claim 1, wherein step (b) includes providing a different link for each advertiser.

3. The method according to claim 1, wherein the link is an address for allowing an interested participant to obtain the information.

4. The method according to claim 3, wherein the address is a URL of a website providing said information.

5. The method according to claim 3, wherein each link is a contact address for allowing an interested participant to request receipt of the information in non-electronic form.

6. The method according to claim 2, wherein each link is an address for allowing an interested participant to obtain the information.

7. The method according to claim 6, wherein the contact address is a URL of a website providing said information.

8. The method according to claim 6, wherein each link is a contact address for allowing an interested participant to request receipt of the information in non-electronic form.

9. The method according to claim 1, wherein the link is a URL of a website operated on behalf of the promoter and providing links to websites of each advertiser.

10. The method according to claim 9, wherein said website offers multilingual data offering linkage to language-selectable websites of the respective advertisers.

11. The method according to claim 1, wherein in step (c) at least some answers are received electronically.

12. The method according to claim 1, wherein in step (c) the questions are presented in an American-style test.

13. The method according to claim 1, wherein the questions are compiled by or on behalf of the advertisers.

14. The method according to claim 1, wherein the questionnaire is distributed as a supplement to a host journal.

15. The method according to claim 1, further including the steps of:
(f) reviewing the advertiser's products and services,
(g) compiling a questionnaire including suitable questions at least some of which require a level of knowledge beyond that of an expected target audience,
(h) compiling source material providing extensive information about the advertiser's products and services and including clues to the questions, and
(i) rendering both the questionnaire and the source material publicly accessible.

16. The method according to claim 1, wherein the targeted readers are notified of the questionnaire via a television program.

17. The method according to claim 1, wherein the questionnaire is publicly broadcast on a media broadcast channel.

18. The method according to claim 17, wherein advance warning of the public broadcast is provided in a supplement to a host journal.

19. The method according to claim 17, wherein the media broadcast channel is a television channel and the questions are posed in a quiz show.

20. The method according to claim 19, wherein the quiz show is consummated by a grand lottery to which correct answers are eligible to enter.

21. The method according to claim 17, wherein the questions are broadcast so as to be displayed on a home viewer's TV screen.

22. The method according to claim 21, wherein answers to the questions are received from home viewers allowing them to participate in the quiz from home.

23. A program storage device readable by machine, tangibly embodying a program of instructions executable by the machine to perform method steps for promoting products of a plurality of advertisers, the method comprising the following steps:
(a) distributing a questionnaire financed by the advertisers, said questionnaire containing a number of questions at least some of which require a level of knowledge beyond that of an expected target audience,
(b) providing in the questionnaire a link to a source of information providing clues as to the answers to the questions and being interspersed with information about the advertisers and their products, and
(c) processing answers the questions received to from interested participants,
(d) marking completely correct answers for entry to a lottery having a cash award financed by the advertisers.

24. A computer program product comprising a computer useable medium having computer readable program code embodied therein for promoting products of a plurality of advertisers, the computer program product comprising:
computer readable program code for causing the computer to distribute a questionnaire financed by the advertisers, said questionnaire containing a number of questions at least some of which require a level of knowledge beyond that of an expected target audience,
computer readable program code for causing the computer to provide in the questionnaire a link to a source of information providing clues as to the answers to the questions and being interspersed with information about the advertisers and their products,
computer readable program code for causing the computer to process answers to the questions received from interested participants, and
computer readable program code for causing the computer to mark completely correct answers for entry to a lottery having a cash award financed by the advertisers.

25. A method for promoting products of a plurality of advertisers, the method comprising the following steps all carried out by a targeted reader:
(a) receiving a questionnaire containing a number of questions at least some of which require a level of knowledge beyond that of an expected target audience,
(b) following a link in the questionnaire to a source of information providing clues as to the answers to the questions and being interspersed with information about the advertisers and their products, and
(c) completing answers to the questions and forwarding to a promoter.

26. The method according to claim 25, wherein step (b) includes following a different link for each advertiser.

27. The method according to claim 25, wherein the link is an address for allowing the targeted reader to obtain the information.

28. The method according to claim 27, wherein the address is a URL of a website providing said information.

29. The method according to claim 27, wherein each link is a contact address for allowing the targeted reader to request receipt of the information in non-electronic form.

30. The method according to claim 26, wherein each link is an address for allowing the targeted reader to obtain the information.

31. The method according to claim 30, wherein the contact address is a URL of a website providing said information.

32. The method according to claim 30, wherein each link is a contact address for allowing the targeted reader to request receipt of the information in non-electronic form.

33. The method according to claim 25, wherein the link is a URL of a website operated on behalf of the promoter and providing links to websites of each advertiser.

34. The method according to claim 33, wherein said website offers multilingual data offering linkage to language-selectable websites of the respective advertisers, and the targeted reader selects one of said language-selectable websites.

35. The method according to claim 25, wherein in step (c) the targeted reader forwards answers electronically to the promoter.

36. The method according to claim 25, wherein in step (c) the questions are presented in an American-style test.

37. The method according to claim 25, wherein the questionnaire is received as a supplement to a host journal.

38. A program storage device readable by machine, tangibly embodying a program of instructions executable by the machine to perform method steps for promoting products of a plurality of advertisers, the method comprising the following steps:
(a) receiving a questionnaire containing a number of questions at least some of which require a level of knowledge beyond that of an expected target audience,
(b) following a link in the questionnaire to a source of information providing clues as to the answers to the questions and being interspersed with information about the advertisers and their products, and
(c) completing answers to the questions and forwarding to a promoter.

39. A computer program product comprising a computer useable medium having computer readable program code embodied therein for promoting products of a plurality of advertisers, the computer program product comprising:
computer readable program code for causing the computer to receive a questionnaire containing a number of questions at least some of which require a level of knowledge beyond that of an expected target audience,
computer readable program code for causing the computer to follow a link in the questionnaire to a source of information providing clues as to the answers to the questions and being interspersed with information about the advertisers and their products, and
computer readable program code for allowing a user to compile answers to the questionnaire and forward the answers to a promoter.

40. A questionnaire containing a number of questions at least some of which require a level of knowledge beyond that of an expected target audience, and containing a link to a source of information providing clues as to the answers to the questions and being interspersed with information about the advertisers and their products.

41. The questionnaire according to claim 40, being distributed as a supplement to a host journal.

42. A method for promoting a business's products or services, including the following steps all carried out by an advertising agency:
(a) reviewing the business's products and services,
(b) compiling a questionnaire including suitable questions at least some of which require a level of knowledge beyond that of an expected target audience,
(c) compiling source material providing extensive information about the business's products and services and including clues to the questions, and
(d) rendering both the questionnaire and the source material publicly accessible.

43. A method for promoting products of a plurality of advertisers, the method comprising the following steps all carried out by a promoter:
(a) distributing a questionnaire financed by the advertisers, said questionnaire containing a number of questions at least some of which relate to the advertisers' products,
(b) receiving answers to the questions from interested participants,
(c) entering completely correct answers to a lottery having a cash award financed by the advertisers, and
(d) awarding the cash award to a wining entry of the lottery.

44. The method according to claim 43, wherein the questionnaire is publicly broadcast on a media broadcast channel.

45. The method according to claim 44, wherein advance warning of the public broadcast is provided in a supplement to a host journal.

46. The method according to claim 44, wherein the media broadcast channel is a television channel and the questions are posed in a quiz show.

47. The method according to claim 46, wherein the quiz show is consummated by a grand lottery to which correct answers are eligible to enter.

48. The method according to claim 46, wherein the questions are broadcast so as to be displayed on a home viewer's TV screen.

49. The method according to claim 48, wherein answers to the questions are received from home viewers allowing them to participate in the quiz from home.
